(19) United States
(12) Patent Application Publication
(10) Pub. No.: US 2026/0061957 A1
(43) Pub. Date: Mar. 5, 2026

(54) BUMPER ARRANGEMENT FOR A MOTOR VEHICLE

(71) Applicants: HOLON GmbH, Paderborn (DE); BENTELER AUTOMOBILTECHNIK GMBH, Paderborn (DE)

(72) Inventors: Waldemar DINIUS, Paderborn (DE); Konstantin TATARINOV, Bielefeld (DE)

(21) Appl. No.: 19/319,652

(22) Filed: Sep. 4, 2025

(30) Foreign Application Priority Data
Sep. 5, 2024 (EP) 24198608.2

(51) Int. Cl. B60R 19/34; B60R 19/18; B60R 19/24

(52) U.S. Cl. CPC B60R 19/34; B60R 2019/1806; B60R 2019/247

(57) ABSTRACT

Bumper arrangement for a motor vehicle, including a cross member and a respective crash box arranged in the region of the ends of the cross member for coupling the bumper arrangement to a longitudinal member of the motor vehicle. The crash box has a profile extruded in the motor vehicle vertical direction. The crash box has a first coupling channel running in the motor vehicle vertical direction. A coupling means engages at least in sections in the first coupling channel and connects the crash box to the cross member. The crash box has, at its end facing away from the cross member, a second coupling channel running in the motor vehicle vertical direction for connecting the crash box to the longitudinal member.

### RELATED APPLICATIONS

The present application claims priority of European Application Number 24198608.2 filed Sep. 5, 2024, the disclosure of which is hereby incorporated by reference herein in its entirety.

### FIELD

The present disclosure relates to a bumper arrangement for a motor vehicle.

### BACKGROUND

Motor vehicles are equipped with bumper arrangements at the front or rear end. These have a cross member that extends almost across the entire width of the vehicle. The cross member itself is coupled to the body and/or longitudinal members of the vehicle via crash boxes. In the event of an impact, the kinetic energy is converted into deformation energy by the crash boxes.

The crash boxes are able to be manufactured by extrusion, so that they have an extruded profile which is formed from several hollow chambers. The profile is extruded in the vertical direction of the vehicle.

A corresponding bumper arrangement is described in JP 201151360 A. In the bumper arrangement described in that case, the crash boxes are welded to the cross member. This is a coupling method between the crash box and the cross member. However, this has the disadvantage that an energy-intensive welding process is required to produce the bumper arrangement. If the crash boxes are connected by welding to the cross member, removal of the components is difficult, such as if the cross member is U-shaped or hat-shaped in cross section and thus has an opening oriented towards the interior of the vehicle along its longitudinal direction, welding the crash boxes to the cross member is often complex.

### SUMMARY

Based on this, the object of the present disclosure is to show an alternative coupling possibility between the crash box and the cross member.

This object is achieved by a bumper arrangement for a motor vehicle.

The bumper arrangement according to the present disclosure for a motor vehicle has a cross member and a crash box arranged in the region of the ends of the cross member or a deformation profile for coupling the bumper arrangement to a longitudinal member of the motor vehicle. The bumper arrangement is able to be arranged at the front or rear of the motor vehicle.

In at least one embodiment of the present disclosure, the cross member has a web and two opposite legs connected to the web. The cross member is formed from an extruded profile extruded in the transverse direction of the motor vehicle. The cross member is hat-shaped or U-shaped in cross section, at least in sections. In the hat-shaped design of the cross member, the upper side of the hat is formed by the web, while the two opposite legs represent the side walls of the hat. The opposite legs also each have a flange at respective ends facing away from the web, which forms the brim of the hat. In the U-shaped design of the cross member, the opposite legs form the parallel legs of the U, while the web connects the opposite legs. Both the hat-shaped and the U-shaped cross members each have an open side along a respective longitudinal direction. The cross member is arranged in the motor vehicle in such a way that the open side is oriented towards the crash boxes.

The crash box has a profile extruded in the vertical direction of the vehicle. The crash box is extruded. This enables cost-effective production of the crash boxes.

The bumper arrangement according to the present disclosure is now characterized in that the crash box has a first coupling channel running in the vertical direction of the motor vehicle. A coupling means engages at least in sections in the first coupling channel and connects the crash box to the cross member. The coupling means is also able to penetrate the coupling channel completely. The crash box has two first coupling channels, into each of which a coupling means engages at least in sections and thus connects the crash box to the cross member. The coupling according to the present disclosure between the crash box and the cross member has the advantage that a material connection and, for example, a welded connection between the cross member and the crash box is no longer necessary. Production costs are able to be saved.

In at least one embodiment of the present disclosure, the crash box has, at its end facing away from the cross member, a second coupling channel running in the vertical direction of the motor vehicle for connecting the crash box to the longitudinal member of the motor vehicle. This means that a material connection and, for example, a welded connection between the crash box and the longitudinal member is able to be avoided. Also in this case production costs are able to be saved.

The bumper arrangement according to the present disclosure is also able to include two longitudinal members.

The cross member is able to have a multi-chamber hollow profile, or a two-chamber hollow profile, along its longitudinal direction and in between its end regions, thus between the coupling regions of the cross member and the crash boxes. In at least one embodiment of the present disclosure, the two hollow profile chambers are arranged one above the other in the vertical direction of the vehicle. In this way, the stability and rigidity of the cross member is able to be increased with a small increase in weight.

In at least one embodiment of the present disclosure, the web of the cross member has a beading extending in the longitudinal direction of the web. The beading is oriented towards the crash boxes. This increases the buckling stiffness of the cross member which is open on one side.

In at least one embodiment of the present disclosure, the crash box is arranged in sections between the opposite legs of the cross member and is in contact with the web and/or the beading of the web. The direct contact between the crash box and the web or the beading of the web creates a continuous load path. In the event of a crash, this enables direct load transfer from the cross member into the crash boxes.

In at least one embodiment of the present disclosure, the crash box has a trapezoidal shape in the longitudinal direction of the vehicle. The width of the crash box increases towards the cross member. This has proven to be advantageous for the deformation behavior of the crash box within the scope of the present disclosure. However, the width of the crash box towards the cross member is able to be reduced.

The crash box has four outer walls that enclose a deformation region. The deformation region itself is formed by inner walls, wherein the outer walls are also able to be considered as belonging to the deformation region. The inner walls are able to extend between the outer walls and in between the corners of the outer walls. In at least one embodiment of the present disclosure, the inner walls are arranged in an X-shape when viewed from the vertical direction of the motor vehicle. In this embodiment, the deformation region has four cavities. The X-shaped arrangement of the inner walls has proven to be advantageous for the deformation behavior of the crash box within the scope of the present disclosure and leads to a uniform compression of the crash box in the longitudinal direction of the vehicle.

Furthermore, in at least one embodiment of the present disclosure, the inner walls arranged in an X-shape each have at least one beading or bend running in the vertical direction of the motor vehicle. The beadings or bends are arranged on the four inner walls in such a way that, viewed from the vertical direction of the vehicle, they are flared in the same direction relative to a contact point of the inner walls. The beadings or bends thus represent a trigger that ensures that the inner walls do not interfere with each other in the event of a crash.

In at least one embodiment of the present disclosure, at least one of the outer walls oriented in the longitudinal direction of the motor vehicle has a beading and/or notch running in the vertical direction of the motor vehicle. The beading is an indentation in the outer wall oriented towards the deformation region, wherein the indentation is able to be formed by a deformation of the side wall. The notch is a recess in the outer wall, which is able to be formed both on the outside and facing the deformation region. The outer walls are able to have multiple beadings or multiple notches or combinations thereof. The beadings or notches ensure that the outer walls oriented in the longitudinal direction of the vehicle buckle or are displaced in the direction of the deformation region in the event of a crash.

In at least one embodiment of the present disclosure, the coupling channels are formed by the extrusion of the crash box. This has the advantage that no additional manufacturing steps are required to form the coupling channels. Alternatively, the coupling channels are also able to be formed by a hole in the crash box. Another alternative is that the coupling channels are formed within sleeves, whereby the sleeves are also able to be formed by the extrusion of the crash box or connected to the crash box.

The coupling channels according to the present disclosure could also be extruded as solid material in the form of round or polygonal solid material sections with the crash box and only be completed by drilling and/or thread cutting in lengthwise sections. On the finished crash box, the coupling channel is hollow or sleeve-like over its entire length, or with two opposite blind holes.

In at least one embodiment of the present disclosure, the coupling channels are closed in cross-section. However, the coupling channels are also able to be crescent-shaped in cross-section. The latter has proven to be advantageous for the extrusion of the crash box. The coupling means is a bolt, a pin, a threaded rod or a screw.

In at least one embodiment of the present disclosure, the coupling means extends through the coupling channel as well as the opposite legs of the cross member or the longitudinal member. In this case, the coupling means is fixed on the side of the legs facing away from the coupling channel, for example, by a nut. The crash box is thus securely connected to the cross member and/or the longitudinal member via the coupling means. Alternatively, the coupling means is able to be joined directly to the cross member and/or the longitudinal member, for example, by a welded connection.

Alternatively, a thread is able to be cut into the coupling channel. In this case, two coupling means are possible, for example, two screws, to engage in sections in the coupling channel. The screws each pass through one of the legs and engage in the thread of the coupling channel.

In at least one embodiment of the present disclosure, the at least one second coupling channel is formed within a sleeve and the sleeve is connected to the crash box by means of a web. This has the advantage that the connection between the crash box and the longitudinal member does not have to be formed directly at the end of the longitudinal member oriented towards the crash box by the coupling means. Depending on the length of the web, the distance between the coupling section and the front of the crash box is able to be increased. This enables a secure coupling between the crash box and the longitudinal member and increases the area required for attaching the coupling means. For example, for screwing on a nut.

In at least one embodiment of the present disclosure, the height of the second coupling channel in the vertical direction of the motor vehicle is lower than the height of the crash box in the vertical direction of the motor vehicle. This allows the longitudinal member to be in direct contact with the front side of the crash box oriented towards the longitudinal member. This enables the formation of a continuous load path so that in the event of a crash, the energy remaining after the deformation of the crash box is able to be transferred to the longitudinal members. Due to the direct contact between the longitudinal member and the crash box, the coupling means connecting the crash box to the longitudinal member is subjected to less stress.

### BRIEF DESCRIPTION OF THE DRAWINGS

Further advantages, features, and properties of the present disclosure are the subject matter of the following description. The figures are purely schematic and are not to scale. In the figures:

FIG. 1 shows a bumper arrangement in a perspective view according to at least one embodiment of the present disclosure,

FIG. 2A, FIG. 2B, FIG. 2C, and FIG. 2D show possible designs of a cross member in cross section according to at least one embodiment of the present disclosure,

FIG. 3 shows a crash box in a perspective view according to at least one embodiment of the present disclosure,

FIG. 4 shows a cross member without crash boxes in a perspective view according to at least one embodiment of the present disclosure,

FIG. 5A and FIG. 5B show a cross member without crash boxes in a perspective view and in section A-A according to at least one embodiment of the present disclosure,

FIG. 6 shows a crash box with a longitudinal member in a perspective view according to at least one embodiment of the present disclosure,

FIG. 7A and FIG. 7B show two embodiments of a coupling of the crash box with a cross member and a longitudinal member in a cross section according to the present disclosure,

FIG. 8A, FIG. 8B, FIG. 8C show possible designs of the crash box in a plan view according to at least one embodiment of the present disclosure, and

FIG. 9 shows a bumper arrangement in a deformed state in a plan view according to at least one embodiment of the present disclosure.

### DETAILED DESCRIPTION

In the figures, the same reference numerals are used for same or corresponding components, although a repeated description is omitted for reasons of simplicity.

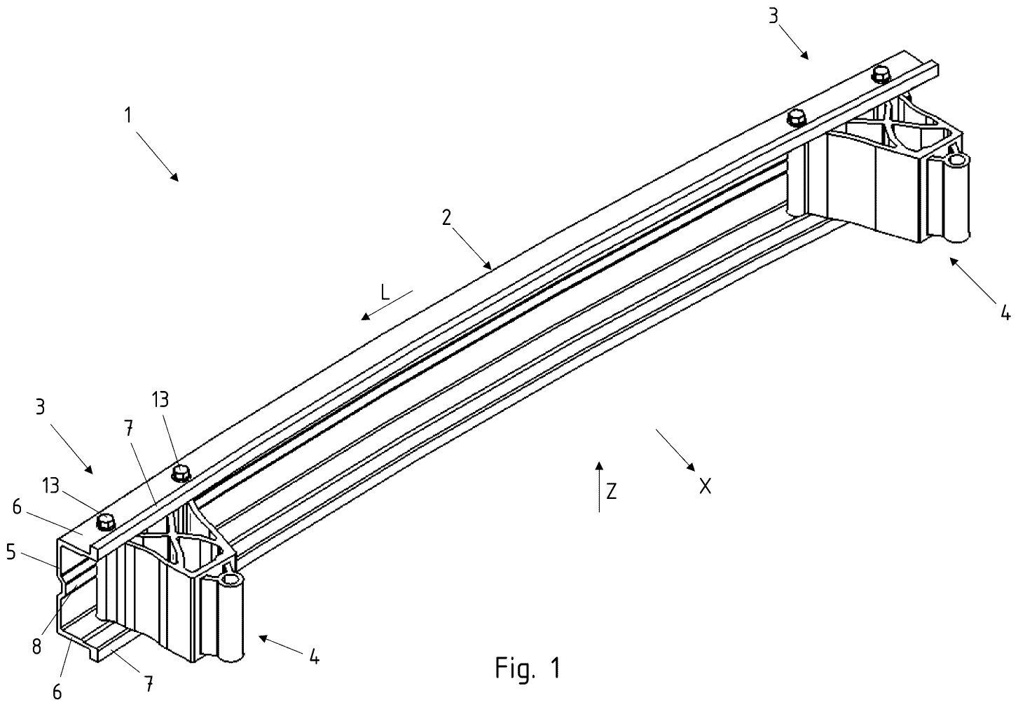

FIG. 1 shows a bumper arrangement 1 according to the present disclosure for a motor vehicle, not shown in detail, including a cross member 2 and a crash box 4 arranged in the region of the ends 3 of the cross member 2 for coupling the bumper arrangement 1 to the motor vehicle.

The cross member 2 has a web 5 and two legs 6 connected to the web 5 and opposite each other. The cross member 2 is also able to have a hat-shaped cross section. The web 5 forms the upper region of the hat, while the legs 6 represent the side walls of the hat. At the ends of the legs 6 facing away from the web 5, a flange 7 is formed which projects outwards orthogonally to the respective leg 6. The flanges 7 form the brim of the hat. The cross member 2 has an open side along its longitudinal direction L, which is oriented in the motor vehicle longitudinal direction X towards the interior of the motor vehicle.

A beading 8 extends in the longitudinal direction L of the web 5. The beading 8 ensures increased buckling stiffness of the open cross member 2.

The crash boxes 4 are arranged in sections between the opposite legs 6 of the cross member 2 and are in contact with the beading 8 of the web 5. The direct contact between the beading 8 and the crash boxes 4 creates a load path so that in the event of a crash, the forces occurring are able to be transferred directly from the cross member 2 to the crash boxes 4.

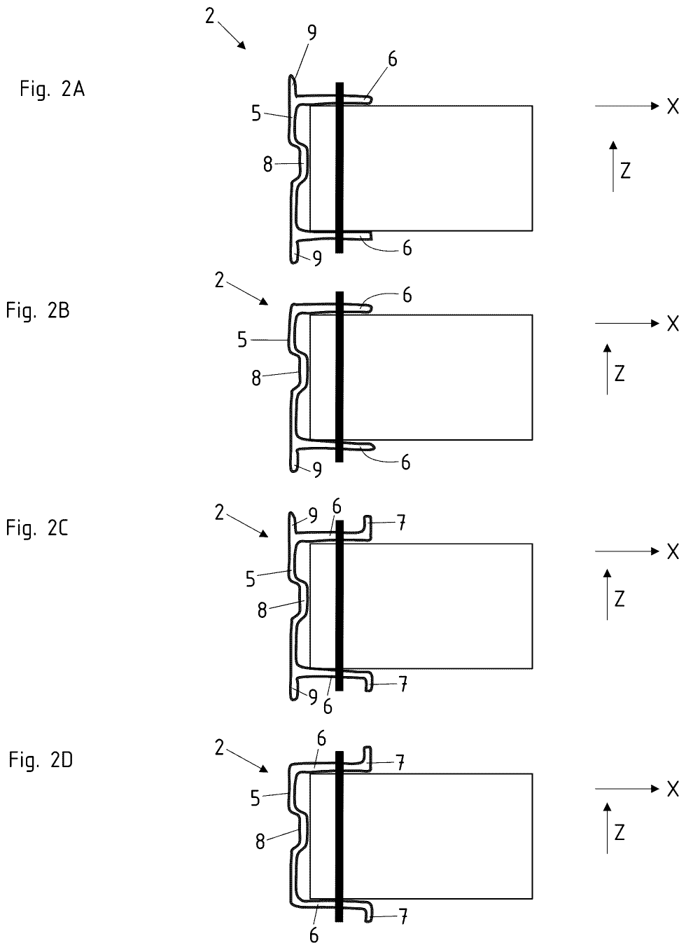

FIG. 2A, FIG. 2B, FIG. 2C, and FIG. 2D show alternative embodiment variants of the cross member 2 in a cross section. FIG. 2A and FIG. 2B each show a U-shaped configuration.

The cross member 2 shown in FIG. 2A has an outwardly projecting flange 9 at each of the transition sections between the web 5 and the leg 6. These form an extension of the web 5 that extends beyond the leg 6.

The embodiment variant shown in FIG. 2B also shows a corresponding leg 6, but this is only formed on one side of the web 5.

FIG. 2C and FIG. 2D each show a hat-shaped profile of the cross member 2. As in the embodiment of the cross member 2 shown in FIG. 1, the legs 6 in this embodiment variant have outwardly angled flanges 7 at respective ends facing away from the web 5. The flanges 7 are aligned orthogonally to the legs 6 and run parallel to the web 5 of the cross member 2.

The alternative design shown in FIG. 2C also has flanges 9 arranged in the transition region between web 5 and leg 6 and projecting outwards, analogous to the variant shown in FIG. 2A.

FIG. 2D does not show any corresponding flanges 9. The hat-shaped design of the cross member 2 shown here corresponds to the embodiment variant shown in FIG. 1.

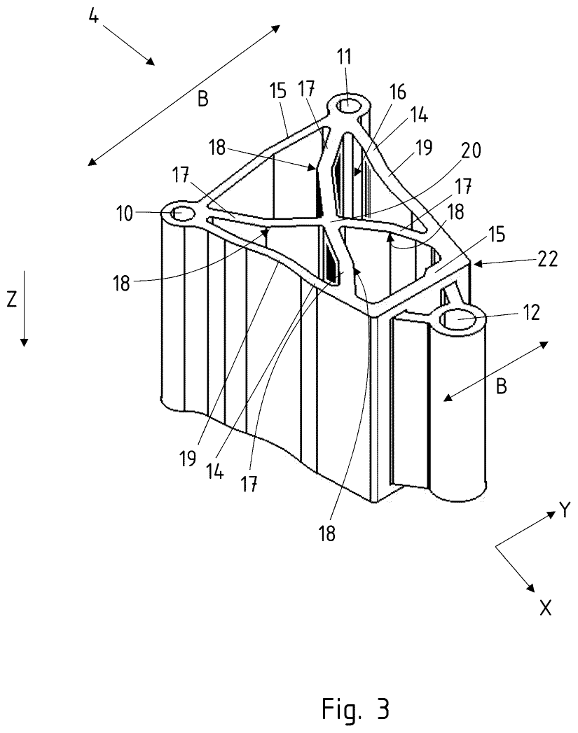

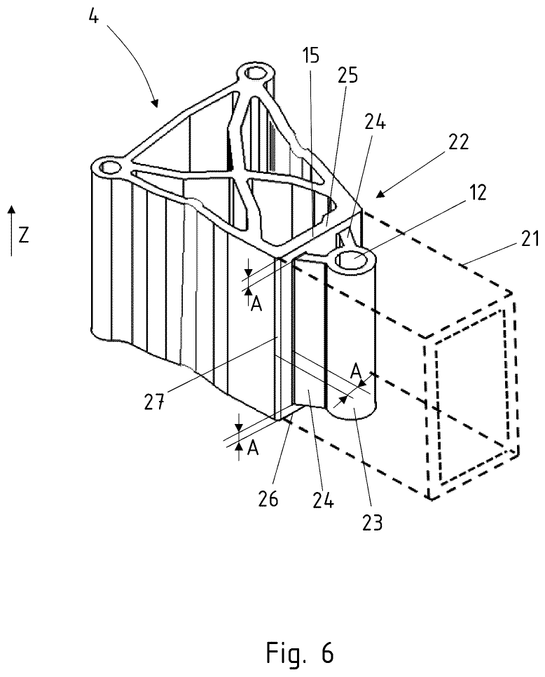

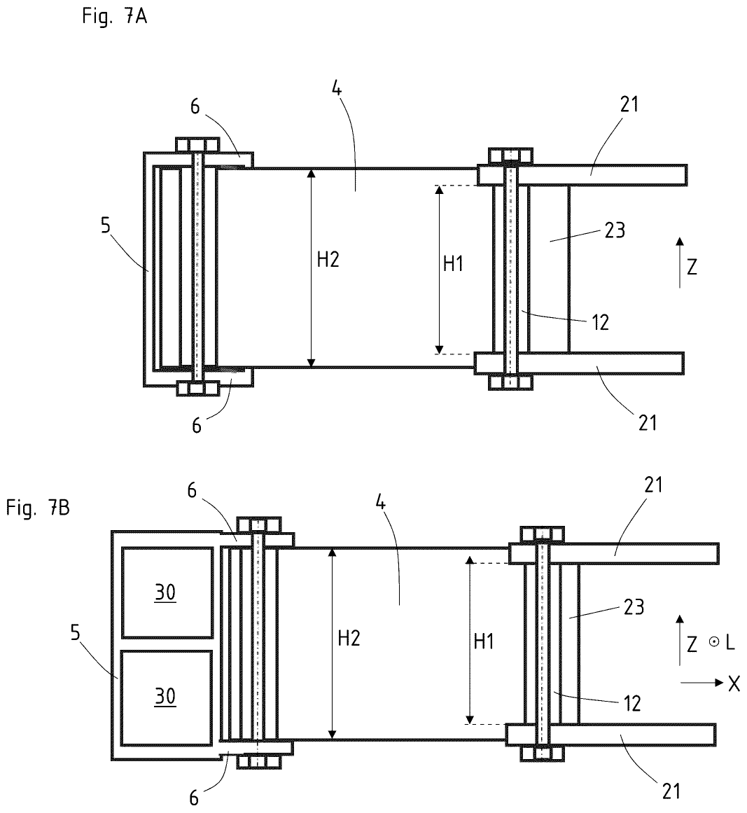

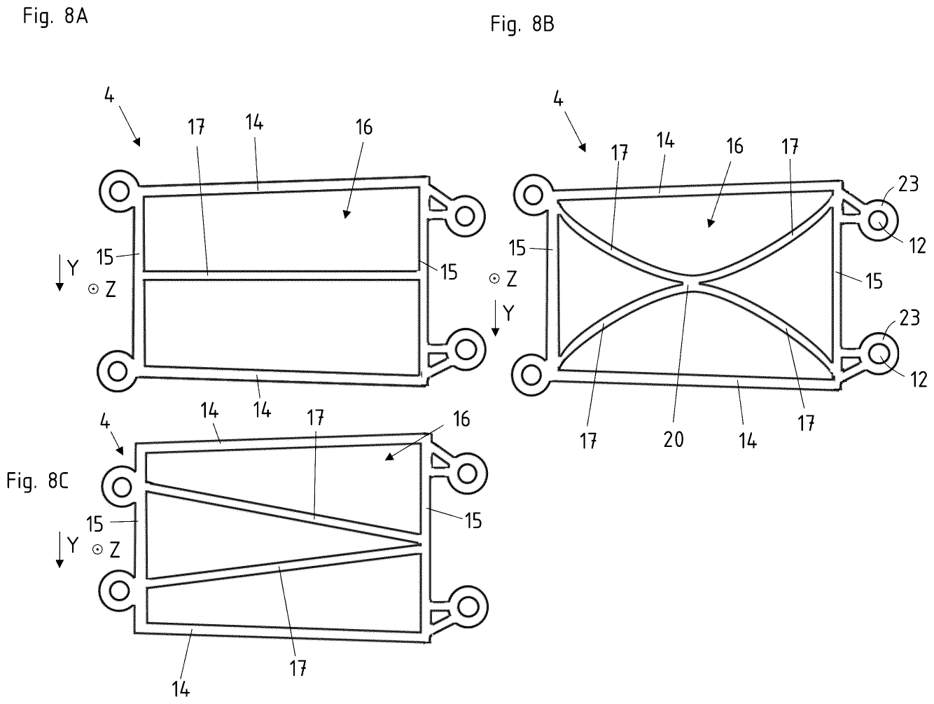

The longitudinal member-side coupling of the crash box 4 is not shown in FIG. 2A, FIG. 2B, FIG. 2C, and FIG. 2D, but is able to be carried out analogously to the coupling means shown in FIG. 3, FIG. 6, FIG. 7A and FIG. 7B, and FIG. 8A, FIG. 8B, and FIG. 8C.

FIG. 3 shows the crash box 4 in perspective. According to the present disclosure, the crash box 4 has a profile extruded in the motor vehicle vertical direction Z. The profile is manufactured by extrusion.

The crash box 4 has a total of three coupling channels 10, 11, 12 running in the motor vehicle vertical direction Z. The coupling channels 10, 11, 12 are formed by the extrusion of the crash box 4. FIG. 1 shows that the coupling channels 10 and 11 are each passed through by a coupling means 13, which connects the crash box 4 to the cross member 2. The connection according to the present disclosure between the cross member 2 and the crash boxes 4 has the advantage of no welding connection between the components. This saves costs during the manufacture of the bumper arrangement 1. Furthermore, a welded connection would be difficult to realize if the crash boxes 4 were arranged in sections between the opposite legs 6 of the cross member 2.

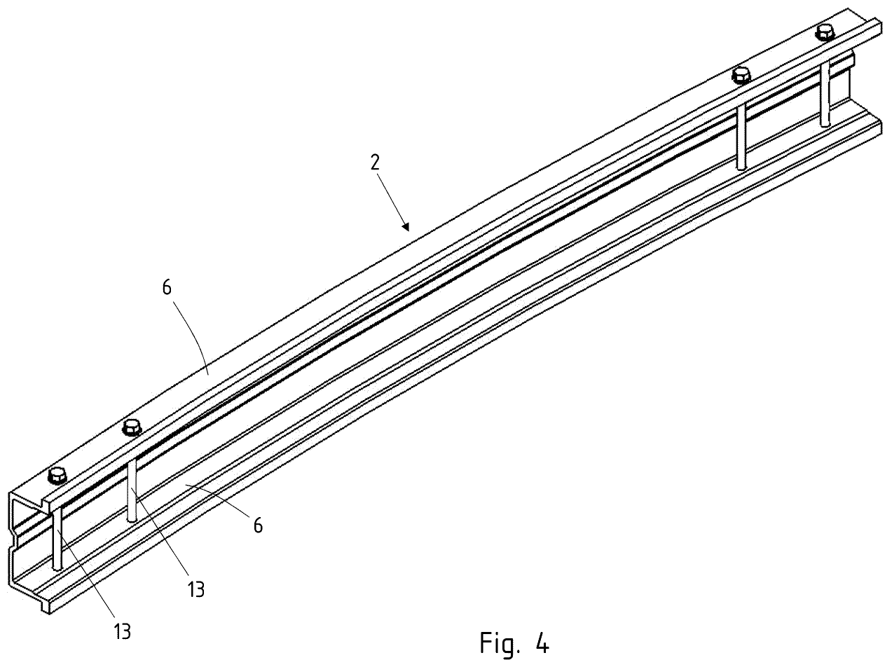

For the sake of clarity, the coupling means 13 are shown again without the crash boxes 4 together with the cross member 2 in FIG. 4. The coupling means 13 are bolts which have a thread at the end so that they are able to be fixed by means of a nut. The coupling means 13 extend through the opposite legs 6 of the cross member 2 and thus enable a secure connection between the crash boxes 4 and the cross member 2.

FIG. 3 shows that the crash box 4 has two outer walls 14 oriented in the motor vehicle longitudinal direction X and two outer walls 15 oriented in the motor vehicle transverse direction Y. The four outer walls 14, 15 enclose a deformation region 16 which is formed from inner walls 17. The outer walls 14, 15 themselves also belong to the deformation region. The inner walls 17 are arranged in an X-shape when viewed from the motor vehicle vertical direction Z. The inner walls 17 each extend from the corner regions formed between the outer walls 14, 15 to the center of the deformation region 16, where the four inner walls 17 meet. The deformation region 16 has four cavities separated from each other by the inner walls 17.

The inner walls 17 each have a bend 18 in the respective central regions. The bends 18 also extend in the motor vehicle vertical direction Z and are aligned such that, viewed from the motor vehicle vertical direction Z, they are angled in the same direction relative to the connection point 20 of the inner walls 17. Correspondingly designed bends 18 have proven to be advantageous for the deformation behavior of the crash boxes 4 within the scope of the present disclosure. In the event of deformation, the inner walls 17 buckle evenly and do not hinder each other.

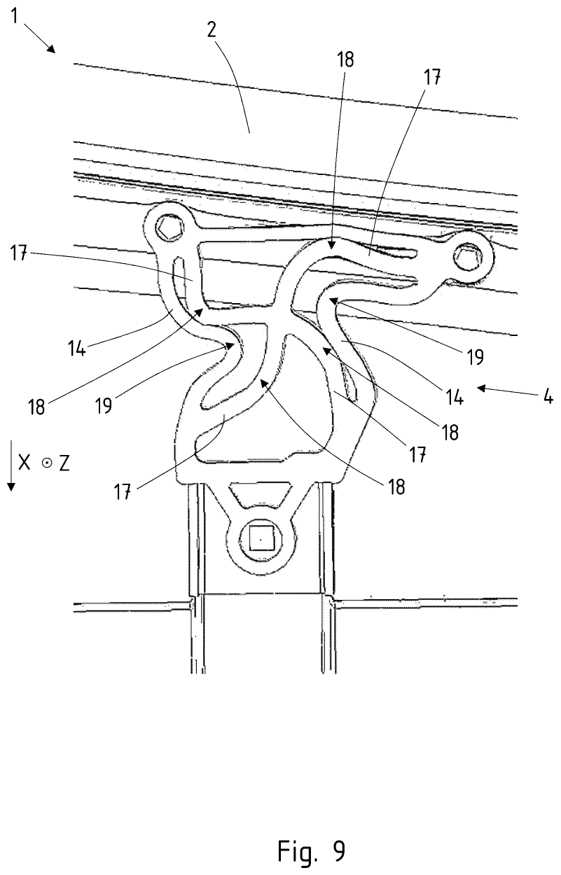

The outer walls 14 oriented in the motor vehicle longitudinal direction X each have a beading 19 running in the motor vehicle vertical direction Z. The beadings 19 are oriented towards the deformation region 16 of the crash box 4. In the event of a crash, the beadings 19 ensure that the outer walls 14 are pressed inwards towards the deformation region 16 when the crash box 4 is deformed. The deformation behavior of the crash box 4 is shown in FIG. 9.

In at least one embodiment of the present disclosure, the crash box 4 has a trapezoidal shape in the motor vehicle longitudinal direction X. The width B of the crash box 4 increases towards the cross member 2. A corresponding profile has proven to be advantageous for the deformation of the crash box 4 within the scope of the present disclosure.

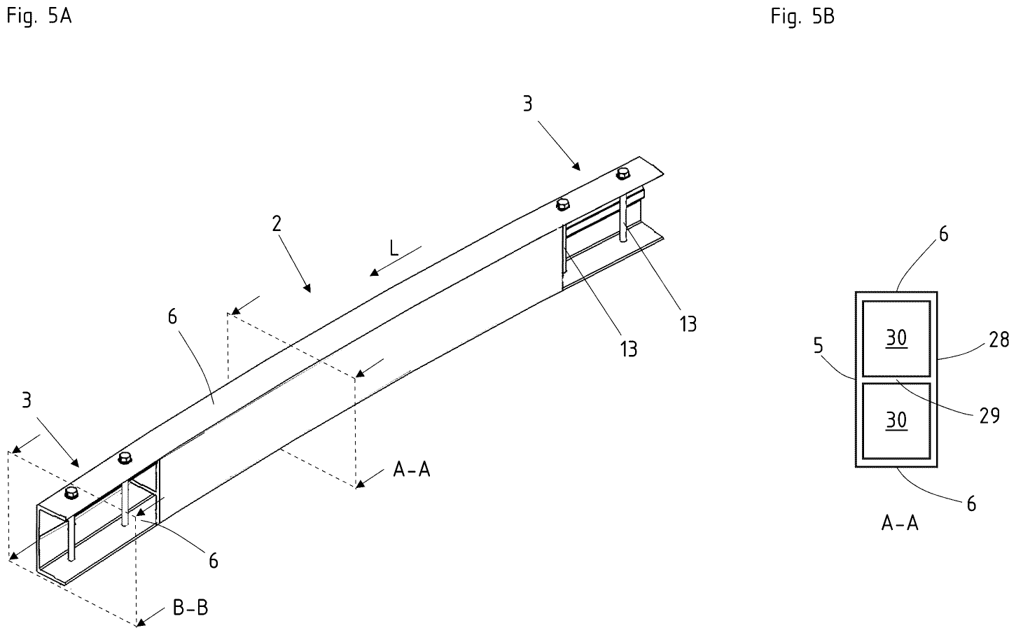

FIG. 5A and FIG. 5B show an alternative embodiment of the cross member 2 without crash boxes 4. FIG. 5A shows the cross member 2 in perspective. Between the end regions 3, the cross member 2 has an extruded two-chamber hollow profile along its longitudinal direction L. FIG. 5B shows the cross section of the cross member 2 in section A-A of FIG. 5A. Between the end regions 3, the cross member has a cover 28 oriented towards the interior of the motor vehicle, which covers the opening of the cross member 2. A separating web 29 is arranged between the opposite legs 6, through which two hollow profile chambers 30 are formed. The two-chamber hollow profile formed between the end regions 3 advantageously increases the stability and rigidity of the cross member 2.

FIG. 6 shows how the crash box 4 is able to be coupled to a longitudinal member 21 of the motor vehicle, which is marked here in sections in dashed lines. According to the present disclosure, the crash box 4 has the second coupling channel 12 on its end 22 facing away from the cross member 2. The coupling channel 12 is formed within a sleeve 23, wherein the sleeve 23 is connected to the crash box 4 by means of two webs 24. The sleeve 23 is also formed by the extrusion of the crash box 4. A coupling means 13, not shown in detail here, passes through the coupling channel 12 and connects the crash box 4 to the longitudinal member 21. The crash box 4 is thus connected to the cross member 2 and the longitudinal member 21 using the same coupling principle.

FIG. 6 further shows that a distance A is formed between the upper edge 25 and lower edge 26 of the outer walls 15 coupled to the sleeve 23 and the webs 24 or the sleeve 23. Therefore, the height of the coupling channel 12 or the sleeve 23 in the motor vehicle vertical direction Z is smaller than the height of the crash box 4 in the motor vehicle vertical direction Z. This is also clearly shown again in FIG. 7A and FIG. 7B. The respective distance A is created by material removal after the extrusion of the crash box 4. A distance A is also formed between the side edges 27 of the outer wall 15 and the webs 24. The formation of corresponding distances A enables the longitudinal member 21 to be in full contact with the crash box 4. This ensures optimal force transmission between crash box 4 and longitudinal member 21.

The webs 24 arranged between the sleeve 23 and the outer wall 15 also ensure that the coupling between the longitudinal member 21 and the crash box 4 does not occur directly at the outermost end of the longitudinal member 21. The webs 24 increase the distance between the sleeve 23 and the end 22 of the crash box 4 facing away from the cross member.

FIG. 7A and FIG. 7B show the coupling of the crash box 4 with the cross member 2 and the longitudinal member 21 in a cross section of the cross member 2. The crash box 4 is respectively arranged between the cross member 2 and the longitudinal member 21. FIG. 7A and FIG. 7B show that the height H1 of the coupling channel 12 or the sleeve 23 in the motor vehicle vertical direction Z is smaller than the height H2 of the crash box 4 in the motor vehicle vertical direction Z. Thus, the longitudinal member 21 is able to rest directly against the crash box 4. A load path is created that is advantageous in the event of a crash.

The embodiment variant shown in FIG. 7A shows the cross section B-B through the coupling region of the cross member 2 according to FIG. 5A, wherein the cross member 2 is coupled here to the crash box 4 and the longitudinal member 21. The crash box 4 is arranged directly between the legs 6 of the cross member 2 and is in contact with the web 5 of the cross member 2. The cover 28 of the cross member 2 is, as also shown in FIG. 5A, recessed for the arrangement of the crash boxes 4 between the legs 6 in the coupling region between the cross member 2 and the crash box 4. Alternatively, the cross member 2 shown in FIG. 7A is also able to have a continuous U-shaped or C-shaped profile in cross section.

FIG. 7B shows an alternative embodiment of the cross member 2. This has an extruded two-chamber hollow profile with two hollow profile chambers 30 along its longitudinal direction L. The legs 6 of the cross member 2 extend over the two-chamber hollow profile in the motor vehicle longitudinal direction X. The crash box 4 is arranged between the legs 6 of the cross member 2 extending in the motor vehicle longitudinal direction X. The projecting regions of the legs 6 are formed only in the two coupling regions between the cross member 2 and the crash boxes 4.

FIG. 8A, FIG. 8B, and FIG. 8C show different alternative design variants of the deformation region 16 of the crash box 4 in a plan view. The crash box 4 shown in FIG. 8A has only one inner wall 17 in the deformation region 16. This extends centrally between the outer walls 15 of the crash box 4 oriented in the motor vehicle transverse direction Y.

The deformation profile 16 of the crash box 4 shown in FIG. 8B has an X-shaped profile. Here, the individual inner walls 17 are arched and each extend in a quarter-circle from the respective corner region between the outer walls 14, 15 to the center of the deformation region 16, where the individual inner walls 17 meet at a connecting point 20.

FIG. 8C shows a further embodiment variant of the deformation region 16. This is formed by two inner walls 17, wherein the inner walls 17 each extend from an outer region, the outer wall 15 oriented towards the cross member 2, to a central region, the outer wall 15 further spaced from the cross member 2. The inner walls 17 and the outer wall 15 oriented towards the cross member 2 thus enclose a triangular cavity. Overall, the deformation region 16, in the exemplary embodiment shown in FIG. 8C, includes three hollow chambers.

FIG. 8A, FIG. 8B, and FIG. 8C further show that the crash box 4 is also able to have two coupling channels 12 running in the motor vehicle vertical direction Z for connecting the crash box 4 to the longitudinal member 21 of the motor vehicle at its end 22 facing away from the cross member 2.

FIG. 9 shows the bumper arrangement 1 according to the present disclosure in a deformed state in a plan view. FIG. 9 illustrates the deformation behavior of the crash box 4. The outer walls 14 oriented in the motor vehicle longitudinal direction X are displaced into the interior of the crash box 4 in the region of their beadings 19, so that components of the motor vehicle adjacent to the crash box 4 are not damaged. The inner walls 17 of the crash box 4 buckle in the region of respective bends 18. Due to the fact that the bends 18 are positioned in the same direction, the inner walls 17 are also deformed in the same direction, so that the inner walls 17 do not hinder each other and an optimal conversion of kinetic energy into deformation energy is ensured. In addition, the inner walls 17 allow the outer walls 14 to be displaced into the interior of the crash box 4 is ensured.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-14. (canceled)

15. A bumper arrangement for a motor vehicle, the bumper arrangement comprising:
a cross member; and
a crash box arranged at each of opposite end regions of the cross member and configured to couple the bumper arrangement to a longitudinal member of the motor vehicle,
wherein the crash box comprises:
(i) a profile extruded in a motor vehicle vertical direction,
(ii) a first coupling channel extending in the motor vehicle vertical direction, wherein a coupling element is configured to engage at least in sections in the first coupling channel and to connect the crash box to the cross member, and
(iii) a second coupling channel, located at an end of the crash box facing away from the cross member and extending in the motor vehicle vertical direction, for connecting the crash box to the longitudinal member.

16. The bumper arrangement according to claim 15, wherein the cross member comprises a web and two opposing legs, and the cross member has a hat-shaped or U-shaped cross section at least in sections thereof.

17. The bumper arrangement according to claim 15, wherein the cross member comprises an extruded profile extruded in a motor vehicle transverse direction.

18. The bumper arrangement according to claim 15, wherein the cross member has a multi-chamber hollow profile along a longitudinal direction of the cross member and in between the end regions of the cross member.

19. The bumper arrangement according to claim 16, wherein the web has a beading extending in a longitudinal direction of the web.

20. The bumper arrangement according to claim 16, wherein the crash box is arranged in sections between the two opposing legs and is in contact with the web.

21. The bumper arrangement according to claim 15, wherein the crash box has a trapezoidal shape in a longitudinal direction of the motor vehicle.

22. The bumper arrangement according to claim 15, wherein the crash box further comprises four outer walls which enclose a deformation region, the deformation region comprises a plurality of inner walls, and the plurality of inner walls being arranged in an X-shape as viewed from the motor vehicle vertical direction.

23. The bumper arrangement according to claim 22, wherein each inner wall of the plurality of inner walls has at least one beading or bend extending in the motor vehicle vertical direction.

24. The bumper arrangement according to claim 22, wherein at least one outer wall of the four outer walls is oriented in a longitudinal direction of the motor vehicle and has a beading or notch extending in the motor vehicle vertical direction.

25. The bumper arrangement according to claim 15, wherein the first coupling channel is integral to the extruded profile of the crash box.

26. The bumper arrangement according to claim 16, wherein the coupling element passes through the two opposing legs of the cross member or is joined directly to the two opposing legs, and the coupling element is a bolt, a pin, a threaded rod or a screw.

27. The bumper arrangement according to claim 15, wherein the second coupling channel extends within a sleeve of the crash box, and the sleeve is connected to the crash box by a web.

28. The bumper arrangement according to claim 15, wherein a height of the second coupling channel in the motor vehicle vertical direction is less than a height of the crash box in the motor vehicle vertical direction.

29. The bumper arrangement according to claim 15, wherein the cross member has a two-chamber hollow profile along a longitudinal direction of the cross member and in between the end regions of the cross member.

30. The bumper arrangement according to claim 19, wherein the crash box is arranged in sections between the two opposing legs and is in contact with the beading of the web.

31. The bumper arrangement according to claim 15, wherein a width of the crash box increases towards the cross member.

32. The bumper arrangement according to claim 15, wherein the first coupling channel is drilled into the crash box or extruded as part of a sleeve.

33. The bumper arrangement according to claim 15, wherein the first coupling channel extends within an extruded sleeve of the crash box.
